(19) United States
(12) Patent Application Publication
(10) Pub. No.: US 2007/0098611 A1
(43) Pub. Date: May 3, 2007

(54) Stabilized flash calcined gibbsite as a catalyst support

(76) Inventor: Xiaolin David Yang, Edison, NJ (US)

Correspondence Address: Libby Babu, Suite 330, 3975 University Drive, Fairfax, VA, 22030, US

(21) Appl. No.: 11/263,242

(22) Filed: Oct. 31, 2005

(51) Int. Cl. B01D 53/94

(52) U.S. Cl. 423/213.2; 502/303

(57) ABSTRACT

A low cost support useful in chemical reactions and automotive arts is formed by rehydrating a flash calcined gibbsite in an aqueous acidic solution. The rehydrated support can be subsequently stabilized by doping with a stabilizing metal such as lanthanum. The alumina support has excellent thermal stability, high sodium tolerance, high activity with low precious metal loading, and high pore volume and surface area.

The present invention relates generally to novel alumina based supports and uses of same in catalysts.

### BACKGROUND OF THE INVENTION

It is well known that the efficiency of supported catalyst systems is often related to the surface area on the support. This is especially true for systems using precious metal catalysts or other expensive catalysts. The greater the surface area, the more catalytic material is exposed to the reactants and less time and less catalytic material is needed to maintain a high rate of productivity.

Alumina (Al₂O₃) is a well-known support for many catalyst systems. It is also well known that alumina has a number of crystalline phases such as alpha-alumina (often noted as α-alumina or α-Al₂O₃), gamma-alumina (often noted as γ-alumina or γ-Al₂O₃) as well as a myriad of alumina polymorphs. Gamma-Al₂O₃ is a particularly important inorganic oxide refractory of widespread technological importance in the field of catalysis, often serving as a catalyst support. Gamma-Al₂O₃ is an exceptionally good choice for catalytic applications because of a defect spinel crystal lattice that imparts to it a structure that is both open and capable of high surface area. Moreover, the defect spinel structure has vacant cation sites giving the gamma-alumina some unique properties. Gamma-alumina constitutes a part of the series known as the activated, transition aluminas, so-called because it is one of a series of aluminas that can undergo transition to different polymorphs. Santos et al. (Materials Research, 2000; vol. 3 (4), pp. 104-114) disclosed the different standard transition aluminas using Electron Microscopy studies, whereas Zhou et al. (Acta Cryst., 1991, vol. B47, pp. 617-630) and Cai et al. (Phys. Rev. Lett., 2002, vol. 89, pp. 235501) described the mechanism of the transformation of gamma-alumina to theta-alumina.

Gamma-alumina is commonly employed as a catalytic support for automotive and industrial catalysts. Gamma alumina has a face-centered cubic close-packed oxygen sublattice structure having a high surface area typically of 150-300 m²/g, a large number of pores with diameters of 30-120 angstroms and a pore volume of 0.5 to >1 cm³/g. These characteristics are what make gamma alumina the specific type of alumina that is often utilized as a catalytic support.

The oxides of aluminum and the corresponding hydrates, can be classified according to the arrangement of the crystal lattice. Some transitions within a series are known; for example, low-temperature dehydration of an alumina trihydrate (gibbsite, Al(OH)₃) above 100 degree Celsius with the presence of steam provides an alumina monohydrate (boehmite, AlO(OH)). Continued dehydration at temperatures above 450 degree Celsius leads to the transformation from boehmite to γ-Al₂O₃. Further heating may result in a slow and continuous loss of surface area and a slow conversion to other polymorphs of alumina having much lower surface areas. Thus, when gamma-alumina is heated to high temperatures, the structure of the atoms collapses such that the surface area decreases substantially. Higher temperature treatment above 1100 degree Celsius ultimately provides α-Al₂O₃, a denser, harder oxide of aluminum often used in abrasives and refractories. While alpha-alumina has the lowest surface area, it is the most stable of the aluminas at high temperatures. Unfortunately, the structure of alpha-alumina is less well-suited to certain catalytic applications because of a closed crystal lattice, which imparts a relatively low surface area to the alpha-alumina particles.

Alumina is ubiquitous as supports and/or catalysts for many heterogeneous catalytic processes. Some of these catalytic processes occur under conditions of high temperature, high pressure and/or high water vapor pressure. The prolonged exposure to high temperature typically such as 1000 degree Celsius combined with a significant amount of oxygen and sometimes steam can result in catalyst deactivation by support sintering. The sintering of alumina has been widely reported in the literature (see for example Thevenin et al, Applied Catalysis A: General, 2001, vol. 212, pp. 189-197) and the phase transformation of alumina due to an increase in operating temperature is usually accompanied by a sharp decrease in surface area. In order to prevent this deactivation phenomenom, various attempts have been made to stabilize the alumina support against thermal deactivation (see Beguin et al., Journal of Catalysis, 1991, vol. 127, pp. 595-604; Chen et al., Applied Catalysis A: General, 2001, vol. 205, pp. 159-172).

For example, it is well known that adding a stabilizing metal, such as lanthanum, to alumina, a process also known as metal-doping, can stabilize the alumina structure. Specifically, U.S. Pat. No. 6,255,358 discloses a catalyst comprising a gamma-alumina support doped with an amount of lanthanum oxide, barium oxide, or a combination thereof effective for increasing the thermal stability of the catalyst. The patent discloses a catalyst comprising per 100 parts by weight of the support from about 10-70 parts by weight cobalt and optional components, including from about 0.5 to 8 parts by weight lanthana. Similarly, U.S. Pat. No. 5,837,634 discloses a process for preparing a stabilized alumina, e.g., gamma alumina, of enhanced resistance to high temperature surface area loss such as by the addition of lanthana to a precursor boehmite alumina. In an example, a mixture of boehmite alumina, nitric acid, and stabilizers such as lanthanum nitrate was dispersed and the mixture aged for 4 hours at 177 degree Celsius (350° F.). Subsequently, the formed powder was calcined for 3 hours at 1200 degree Celsius.

In general, the prior art has focused on the stabilization of alumina, mainly gamma alumina, by using a small amount of lanthana, typically below 10%, and in most practices between 1-6 wt. %. In “Characterization of lanthana/alumina composite oxides,” S. Subramanian et al., Journal of Molecular Catalysis, Volume 69, 1991, pages 235-245, lanthana/alumina composite oxides were formed. It was found that as the lanthana weight loading increased, the surface area of the lanthana dispersed in the composite oxide also increased and reached a plateau at 8% La₂O₃ loading. It was also found that the total BET surface area of the composite oxide decreased sharply as the lanthana loading increased above 8%. The composite oxides were prepared by the incipient wetness procedure in which the alumina was impregnated with lanthanum nitrate hexahydrate and the precursors dried and then calcined at 600 degree Celsius for 16 hours.

For most of the lanthana-doped alumina compositions, the lanthanum is in the form of lanthanum oxide. In “Dispersion Studies on the System La₂O₃/Y-Al₂O₃,” M. Bettman et al., Journal of Catalysis, Volume 117, 1989, pages 447-454, alumina samples with different lanthanum concentrations were produced by impregnation with aqueous lanthanum nitrate, followed by calcination at various temperatures. It was found that up to a concentration of 8.5 μmol La/m², the lanthana was in the form of a 2-dimensional overlayer, invisible by XRD. For greater lanthana concentrations, the excess lanthana formed crystalline oxides detectable by XRD. In samples calcined to 650 degree Celsius, the crystalline phase was cubic lanthanum oxide. After calcination at 800 degree Celsius, the lanthana reacted to form the lanthanum aluminate, LaAlO₃.

Automotive catalysts predominately utilize alumina supports having high thermal stability and high surface area. Having high surface area is important for supporting catalysts and providing the catalysts with sufficient effective area to work. For these reasons, gamma alumina is the most used type of alumina employed in automotive, chemical and high temperature catalytic applications.

Rho-alumina, also known as flash-calcined gibbsite, is one of the most important members of the alumina family. Two most striking characteristic features of rho-alumina are its high porosity and low cost. However, rho-alumina has several disadvantages that limit rho-alumina's greater usefulness. For instance, rho-alumina is unstable, highly reactive due to its high free energy, and because of the fast dehydration process used to form rho-alumina, is amorphous. Although rehydration helps to some degree in the formation of crystalline boehmite structure, still, the resulting material largely has an ill-defined structure in term of pores and surfaces that lead to its low thermal stability. High sodium impurity levels in rho-alumina further undermine its usefulness for those applications that are very sensitive to sodium impurity such as precious-metal catalysis. Due to these shortcomings, rho-alumina has not been used with high temperature catalysts, e.g., three way catalysts (“TWC”).

TWC catalysts have utility in a number of fields including the abatement of nitrogen oxide (NOx), carbon monoxide (CO) and hydrocarbon (HC) pollutants from internal combustion engines, such as automobile and other gasoline-fueled engines. Three-way conversion catalysts are polyfunctional because they have the ability to substantially and simultaneously catalyze the oxidation of hydrocarbons and carbon monoxide and the reduction of nitrogen oxides. Emissions standards for nitrogen oxides, carbon monoxide, and unburned hydrocarbon contaminants have been set by various government agencies and must be met by new automobiles. In order to meet such standards, catalytic converters containing a TWC catalyst are located in the exhaust gas line of internal combustion engines.

TWC catalysts exhibiting good activity and long life comprise one or more platinum group metals, e.g., platinum, palladium, rhodium, ruthenium, and iridium. These catalysts are employed with a high surface area refractory oxide support. The refractory metal oxide can be derived from aluminum, titanium, silicon, zirconium and cerium compounds, preferably resulting in the oxides with the preferred refractory oxides including at least one of alumina, titania, silica, zirconia and ceria. Generally, the TWC catalysts are supported by gamma-alumina.

The TWC catalytic support is carried on a suitable carrier or substrate such as a monolithic carrier comprising a refractory ceramic or metal honeycomb structure, or refractory particles such as spheres or short, extruded segments of a suitable refractory material.

As emphasized above, high surface refractory metal oxides are often employed as a support for many of the catalytic components. For example, high surface area alumina materials, also referred to as “gamma alumina” or “activated alumina”, used with TWC catalysts typically exhibit a BET (Brunauer, Emmett, and Teller) surface area in excess of 60 square meters per gram (“m²/g”), and often up to about 200 m²/g or more. Such activated alumina is usually a mixture of the gamma and delta phases of alumina, but may also contain substantial amounts of eta, kappa and theta alumina phases. Refractory metal oxides other than activated alumina may be utilized as a support for at least some of the catalytic components in a given catalyst. For example, bulk ceria, zirconia, alpha alumina and other materials are known for such use. Although many of these materials have a lower BET surface area than activated alumina, that disadvantage tends to be offset by the greater durability of the resulting catalyst.

Exhaust gas temperatures can reach 1000 degree Celsius in a moving vehicle and such elevated temperatures can cause activated alumina, or other support material, to undergo thermal degradation with accompanying volume shrinkage especially in the presence of steam. During this degradation, the catalytic metal becomes sintered on the shrunken support medium with a loss of exposed catalyst surface area and a corresponding decrease in catalytic activity.

To prevent sintering of catalytic metals, the unstable support is doped with a stabilizing material similar to the process described above. The stabilization of TWC catalysts are known in the art. For example, U.S. Pat. No. 4,171,288 discloses a method to stabilize alumina supports against such thermal degradation by the use of materials such as zirconia, titania, alkaline earth metal oxides such as baria, calcia, or strontia, or rare earth metal oxides such as ceria, lanthana, and mixtures of two or more rare earth metal oxides.

U.S. Pat. No. 4,438,219 discloses an alumina catalyst, stable at high temperatures, for use on a substrate. The stabilizing material is derived from barium, silicon, rare earth metals, alkali and alkaline earth metals, boron, thorium, hafnium, and zirconium. Barium oxide, silicon dioxide, and rare earth oxides including lanthanum, cerium, praseodymium, and neodymium are preferred. Contacting the stabilizing material with a calcined alumina film permits the calcined alumina film to retain a high surface area at higher temperatures.

U.S. Pat. Nos. 4,476,246, 4,591.578 and 4,591,580 disclose three-way catalyst compositions comprising alumina, ceria, an alkali metal oxide promoter, and Noble metals. U.S. Pat. Nos. 3,993,572 and 4,157,316 describe attempts to improve the catalyst efficiency of Pt/Rh based TWC systems by incorporating a variety of metal oxides, e.g., rare earth metal oxides such as ceria and base metal oxides such as nickel oxides. U.S. Pat. No. 4,591,518 discloses a catalyst comprising an alumina support with catalytic components consisting essentially of a lanthana component, ceria, an alkali metal oxide, and a platinum group metal. U.S. Pat. No. 4,591,580 discloses an alumina supported platinum group metal catalyst modified to include support stabilization by lanthana or lanthana rich rare earth oxides, double promotion by ceria and alkali metal oxides and optionally nickel oxide.

U.S. Pat. No. 4,294,726 discloses a TWC catalyst composition containing platinum and rhodium obtained by impregnating a gamma alumina carrier material with an aqueous solution of cerium, zirconium and iron salts or mixing the alumina with oxides of, respectively, cerium, zirconium and iron, and then calcining the material at 500 degree Celsius to 700 degree Celsius. in air after which the material is impregnated with an aqueous solution of a salt of platinum and a salt of rhodium dried and subsequently treated in a hydrogen-containing gas at a temperature of 250 degree Celsius-650 degree Celsius. The alumina may be thermally stabilized with calcium, strontium, magnesium or barium compounds. The ceria-zirconia-iron oxide treatment is followed by impregnating the treated carrier material with aqueous salts of platinum and rhodium and then calcining the impregnated material.

U.S. Pat. No. 4,504,598 discloses a process for producing a high temperature resistant TWC catalyst. The process includes forming an aqueous slurry of particles of gamma or activated alumina and impregnating the alumina with soluble salts of selected metals including cerium, zirconium, at least one of iron and nickel and at least one of platinum, palladium and rhodium and, optionally, at least one of neodymium, lanthanum, and praseodymium. The impregnated alumina is calcined at 600 degree Celsius and then dispersed in water to prepare a slurry which is coated on a honeycomb carrier and dried to obtain a finished catalyst. A full discussion of TWC can be derived from U.S. Pat. No. 6,777,370, which is incorporated by reference.

Due to the disadvantageous characteristics of rho-alumina, rho alumina has not been used with TWCs or other high temperature catalysts. TWCs have for the most part used the more expensive gamma alumina supports due to gamma alumina's high surface area, high purity and good stability. It has long been a desire in the catalytic art to provide a form of alumina that has excellent thermal and hydrothermal stability, can be provided with a low, but effective, precious metal content and is inexpensive. Such a catalyst support would have expanding uses.

### SUMMARY OF THE INVENTION

In accordance with the present invention, a novel catalyst support is made to replace gamma-alumina and other active aluminas for high temperature catalysis applications. The new catalyst support is made from a low cost flash-calcined gibbsite (or rho-alumina) by a simple chemical treatment and has excellent thermal stability, high sodium tolerance, high activity with low precious metal loading, and high pore volume and high surface area. In this invention, rho-alumina (flash-calcined gibbsite) is rehydrated in an aqueous acidic solution. Additional improvements are obtained by doping the rehydrated rho alumina with a stabilizing metal followed by calcination. Once stabilized, the resulting catalyst support, can be effectively used in high temperature applications including as a catalyst support for TWC catalysts.

### DETAILED DESCRIPTION OF THE INVENTION

The present invention is directed to stabilized, rehydrated flash-calcined gibbsite (or rho-alumina) catalyst support and method of making such support for use in chemical and automotive catalytic processes. The stabilized, rehydrated flash-calcined gibbsite (or rho-alumina) is processed into a stable catalyst support having characteristics similar to that of a gamma-alumina and other forms of activated aluminas. The stabilized, rehydrated flash-calcined gibbsite (or rho-alumina) not only provides a low cost catalyst support due to its simple manufacturing process, but also offers a novel route of making high-grade alumina for use as a catalyst support at high temperatures such as three way conversion (TWC) catalysts.

High grade gamma-alumina is obtained mainly by the calcination of high purity boehmite or pseudo-boehmite. Currently, the dominant process of making boehmite or pseudo-boehmite is from the so-called Ziegler process owned by Sasol Corporation. In the Ziegler process aluminum sheets are first dissolved in alcohols and then hydrolyzed. Boehmite or pseudo-boehmite is produced as a by-product of the Ziegler process. Low grade pseudo-boehmite can be also obtained by the precipitation of aluminum-containing chemicals such as the reaction of sodium aluminate and aluminum sulfate. High-grade gamma-alumina is needed for TWC and other high temperature catalyst applications. It is highly desirable to have alternative production routes to produce catalyst substrates that can replace the high-grade alumina.

The precursor for the present invention starts with rho alumina, also known as flash-calcined gibbsite. Rho-alumina is a different raw material than the boehmite or pseudo-boehmite raw materials used to make gamma alumina. As implied by its name, flash-calcined gibbsite is obtained mainly by a rapid, usually in about one second of contact time with heat, dehydration of alumina trihydrates, such as gibbsite and bayerite, though heating alumina trihydrates in vacuum for a longer period of time also forms rho alumina. Rho-alumina may be made using any alumina trihydrate or aluminum hydroxide. Rho-alumina is advantageous for being highly porous and inexpensive to produce and is utilized as adsorbents, catalysts, and catalytic support material in low temperature catalytic applications. However, when gibbsite or bayerite is flash-calcined, an amorphous rho-alumina is produced which cannot be used as a catalytic support in high temperature applications. The amorphous nature of rho-alumina causes the activity level of rho-alumina to quickly decrease in high temperature applications. Thus, rho-alumina has not been utilized as a catalytic support in the same respect as gamma alumina since the crystalline structure of gamma alumina, and the attendant properties of high porosity and high surface area are favored for use in high temperature applications.

These and other disadvantageous qualities of rho-alumina can be overcome with the novel preparations of this invention to allow rho-alumina to function effectively as a support in high temperature catalytic reactions. For instance, rehydrating rho-alumina can result in a N₂ BET surface area of up to about 400 m²/g. This makes rho-alumina a very useful and inexpensive adsorbent and catalyst for many large scale industrial applications. Also, thermal stabilization of rho-alumina by the addition of a stabilizing metal such as lanthanum (La-doping) followed by calcination has demonstrated profound improvements in the thermal stability, surface properties, and Na-tolerance of the rehydrated rho-alumina.

Normally, rehydration of alumina involves adding a rho alumina slurry to water. In the process of the present invention, the rho-alumina is rehydrated in an aqueous acidic environment having a pH generally of about 3. The acid included in the rehydrating solution can be organic such as formic, acetic, oxalic, glycolic, etc., or inorganic such as a nitric acid. The pH range of the aqueous solution used for acidic rehydration is preferably about 1-7. More preferably, the pH is about 1-5. Most preferably, the pH range of the solution used for acidic rehydration is 2-4. Adding an acidic aqueous solution to the rho-alumina not only rehydrates the rho-alumina, but also leaves the rho-alumina with low sodium impurity levels.

Rho-alumina has not been used in many catalytic applications because it possesses high levels of sodium, generally about >2000 ppm. In this invention, by rehydrating the rho-alumina with an aqueous acidic solution, sodium impurities are leached out or otherwise exchanged or removed from the alumina. The sodium impurity level in accordance with this invention will generally be <400 ppm, and more preferably <100 ppm. After leaching is complete, the rehydrated rho-alumina will have a higher pore volume than the pore volume of the flash-calcined gibbsite, which is approximately about 200 m²/g.

The reaction time for rehydrating the rho-alumina can be from 0.5 to 24 hours, preferably 1-8 hours, most preferably 1-3 hours. The reaction temperature for rehydrating rho-alumina using an acidic solution can range from 50-120 degree Celsius. Preferably the rho-alumina can be rehydrated between a temperature of 70-120 degree Celsius. Most preferably the rho-alumina can be rehydrated between a temperature 80-120 degree Celsius. A reaction time of 2 hours and reaction temperature at about 95-100 degree Celsius is preferred for porosity optimization from a practical stand point, although other combinations of the reaction variables should lead to a similar product.

It is common practice to thermally stabilize alumina in order for the alumina to function as a high temperature catalyst support. Although metal-stabilized alumina has been well-studied and practiced in the catalytic arts, stabilization of rehydrated rho-alumina by metal doping has not been intensely evaluated nor considered for use in catalytic applications. Preferably the rehydrated rho-alumina is impregnated with known stabilizer precursors and then calcinced to form a stabilized metal oxide dispersed onto the alumina. The stabilizing metals include alkaline earth metals (Mg, Ca, Sr, Ba), boron, silicon, phosphorus, and rare-earth metals or combinations thereof with lanthanum as the most preferred. In the case of phosphorus, phosphorus precursor reacts with alumina to form surface aluminophosphate structure which stabilizes the alumina.

For example, if lanthanum is used as the stabilizing metal, the lanthanum will become uniformly distributed throughout the rho-alumina imparting advantageous qualities such as thermal stability and attrition resistant properties to the rehydrated rho-alumina. Though any lanthanide series metal compound may be used herein, lanthanum is the most common and most practical for use. The lanthanum will be present in the finally prepared support alone or the catalyst composition in the form of an oxide, preferably lanthanum oxide. The usual precursor material is a salt of lanthanum.

The incorporation of the stabilizing metal can be accomplished either by impregnating rehydrated rho-alumina with a metal salt, such as lanthanum nitrate and acetate, by incipient wetness; through spray-drying a slurry of lanthanum nitrate and rehydrated rho-alumina; or by a solid-state reaction of the rehydrated rho-alumina with a lanthanum salt such as lanthanum carbonate at or above 800 degree Celsius.

In the present invention, the rehydrated rho-alumina is doped with 0-24 wt % of the stabilizing metal. More preferably 0.1-12 wt % of the stabilizing metal is incorporated into the rehydrated rho-alumina. Even more preferred is the incorporation of 1-12 wt. % of the stabilizing metal into the rehydrated rho-alumina. The rehydrated rho-alumina may also be doped with either 3 wt. % or 4 wt. % the stabilizing metal.

After the stabilizing metal has been incorporated into the rehydrated rho-alumina, the rehydrated rho-alumina is calcined. Calcination occurs at or above 550 degree Celsius to up to about 1100 degree Celsius, more preferably from 550 degree Celsius-850 degree Celsius. The lower calcination temperature range is advantageous in that less energy is required to calcine the alumina while still being sufficient to burn off anionic components such as nitrates. Moreover, porosity of the alumina is maintained. Calcination is necessary to make the rehydrated rho-alumina stable and inert so as not to interact with the catalyst. As a result of processing the rho-alumina as described above, the stabilized, rehydrated rho-alumina has good stability, has a high surface area and pore volume and has the ability to hold a high amount of dispersed metals. In fact, it has been found that the surface area of rehydrated rho-alumina can be over 80 m²/g after being calcined at 815 degree Celsius (1500 F). Typically a BET surface area of 120 m²/g and higher have been found, which compares to gamma alumina and even lanthanum doped gamma alumina. Also, the pore volume of stabilized rehydrated rho-alumina will be typically at least 0.20 cc/g, preferably at least 0.30 cc/g, more preferably at least 0.35 cc/g with pore volumes over 0.40 cc/g having been found, which is again comparable to gamma alumina. These profound improvements over untreated rho-alumina allow the stabilized rehydrated rho-alumina to be employed in many catalytic applications not previously considered such as in catalytic applications, including high temperature applications that had mainly used the costly gamma alumina. Such high temperature applications include chemical applications where the temperature ranges from 400-700 degree Celsius, even 800 degree Celsius and in automotive applications wherein temperatures as high as or higher than about 1000 degree Celsius are found.

By being able to hold high amounts of dispersed metals, the low cost stabilized rho-alumina may be used with any catalyst that utilizes alumina-based supports. For instance, the lanthanum-doped, rehydrated rho-alumina can serve as a support for catalysts employed in high temperature applications requiring high surface areas e.g., three way catalysts (TWC).

The TWC catalyst comprises refractory oxide support(s) used to support precious metal(s). At least one precious metal component is utilized in the TWC with preferred precious metal components selected from gold, silver, platinum, palladium, rhodium, ruthenium and iridium, with more preferred precious metals components selected from at least one of platinum, palladium and rhodium. In the present invention, the La-doped, rehydrated rho-alumina serves as the refractory oxide support used to support the precious metal components. As shown in the examples below, the combination of the La-doped, rehydrated rho-alumina with the TWC catalysts exhibit good conversion rates of hydrocarbons, carbon monoxide and nitrogen oxides.

The catalytic compositions made by the present invention can be employed to promote chemical reactions, such as hydrogenation, dehydrogenation, hydrorefining, desulfurization, dehydration, Fisher-Tropsch gas-to-liquid conversion, oxychlorition, alkylation, hydroformylation, Claus Reaction, water-gas-shift reaction, ammonium oxidation, methanation and especially the oxidation of carbonaceous materials, e.g., carbon monoxide, hydrocarbons, oxygen-containing organic compounds, and the like, to products having a higher weight percentage of oxygen per molecule such as intermediate oxidation products, carbon dioxide and water, the latter two materials being relatively innocuous materials from an air pollution standpoint.

Here, in these chemical reactions, the catalyst or catalyst promoter will contain at least one precious metal, an alkaline metal, an alkaline earth metal or a base metal. Suitable base metals include titanium, vanadium, chromium, manganese, iron, cobalt, nickel, copper, zinc, zirconium, niobium, molybdenum, and tungsten. The metals will be supported by the stabilized rehydrated flash calcined gibbsite.

Advantageously, the catalytic compositions can be used to provide removal from gaseous exhaust effluents of uncombusted or partially combusted carbonaceous fuel components such as carbon monoxide, hydrocarbons, and intermediate oxidation products composed primarily of carbon, hydrogen and oxygen, or nitrogen oxides. Although some oxidation or reduction reactions may occur at relatively low temperatures, they are often conducted at elevated temperatures of, for instance, at least about 100 degree Celsius, typically about 150 degree Celsius to 900 degree Celsius, and generally with the feedstock in the vapor phase. The materials which are subject to oxidation generally contain carbon, and may, therefore, be termed carbonaceous, whether they are organic or inorganic in nature. The catalysts are thus useful in promoting the oxidation of hydrocarbons, oxygen-containing organic components, and carbon monoxide, and the reduction of nitrogen oxides.

These types of materials may be present in exhaust gases from the combustion of carbonaceous fuels, and the catalysts are useful in promoting the oxidation or reduction of materials in such effluents. The exhaust from internal combustion engines operating on hydrocarbon fuels, as well as other waste gases, can be oxidized by contact with the catalyst and molecular oxygen which may be present in the gas stream as part of the effluent, or may be added as air or other desired form having a greater or lesser oxygen concentration. The products from the oxidation contain a greater weight ratio of oxygen to carbon than in the feed material subjected to oxidation. Many such reaction systems are known in the art.

In general, the method of the present invention for forming the catalyst support, involves obtaining a commercially available flash calcined gibbsite and rehydrating the flash-calcined gibbsite under acidic conditions to form the rehydrated rho-alumina. Once the rehydrated rho-alumina is obtained, it is stabilized for high temperature applications by the incorporation of stabilization metals such as lanthanum and finally calcined.

The low cost rehydrated rho-alumina catalyst support having excellent thermal and hydrothermal stability may be utilized in any catalytic application that normally uses gamma alumina. As mentioned above, the present support may be utilized in automotive applications, high temperature applications or chemical processing applications including and not limited to oxidation, hydrogenation, dehydrogenation, hydrorefining, desulfurization, dehydration, Fisher-Tropsch gas-to-liquid conversion, oxychlorition, alkylation, hydroformylation, Claus Reaction, water-gas-shift reaction, methanation.

The present invention is illustrated further by the following examples which are not intended to limit the scope of this invention.

### EXAMPLE 1

Preparation of Rehydrated Flash-Calcined Gibbsite:

400 g of flash calcined gibbsite (rho-alumina), CP powder manufactured by Almatis AC, Inc. of Vidalia, La., having a BET surface area 268 m² μg, and Na₂O impurity 2500 ppm, was added to 1600 g of de-ionized (DI) water while stirring. Slowly 11.9 g of formic acid (98% from VWR) was added to the slurry while stirring rigorously. The acidified slurry was heated to 95 degree Celsius and the temperature was held for 2 hours with stirring. After the two hours, the slurry was filtered and washed with hot DI-water three times and the solid was dried at 105 degree Celsius over night. The rehydrated flash calcined gibbsite had a surface area of 350-420 m²/g and Na impurity between 50-500 ppm expressed in Na₂O.

### EXAMPLE 2

Preparation of Lanthana Doped, Rehydrated Flash-Calcined Gibbsite (3% La) by Incipient Wetness:

47.6 g of La(NO₃)₃.6H₂O (from Alfa Aesar) was dissolved in 300 g of DI-water. Then 550 g of the rehydrated flash calcined gibbsite, as formed in Example 1, was impregnated with the above solution. The solid was dried and calcined at 815 degree Celsius (1500° F.) in air for 2 hours. The resulting lanthana-doped, rehydrated flash calcined gibbsite had a surface area about 120-150 m²/g.

### EXAMPLE 3

Preparation of Lanthana Doped, Rehydrated Flash Calcined Gibbsite (3% La) by Spray-Drying:

A slurry was made of 3.5 lb of rehydrated flash calcined gibbsite, as formed in Example 1, 4.9 lb of DI-water, and 119 g of La(NO₃)₃.6H2O (from Alfa Aesar). The slurry was spray-dried and the microspheres were calcined at 815 degree Celsius (1500° F.) in air for two hours. The resulting lanthana doped, rehydrated flash calcined gibbsite had a surface area between 120-150 m²/g.

### EXAMPLE 4

Preparation of Silica Doped, Rehydrated Flash Calcined Gibbsite (3% Si) by Incipient Wetness:

33 g of colloidal silica (LUDOX AS-40 from Aldrich) was diluted in 106 g of DI-water. Then 200 g of the rehydrated flash calcined gibbsite, as formed in Example 1, was impregnated with the above solution. The solid was dried and calcined at 760 degree Celsius (1400° F.) in air for 2 hours. The resulting silica-doped, rehydrated flash calcined gibbsite had a surface area about 150-170 m²/g.

### EXAMPLE 5

Preparation of Phosphorus Doped, Rehydrated Flash Calcined Gibbsite (3% P) by Incipient Wetness:

2.04 g of (NH₄)H₂PO₄ (from Aldrich) was dissolved in 10 g of DI-water. Then 22.2 g of the rehydrated flash calcined gibbsite, as formed in Example 1, was impregnated with the above solution. The solid was dried and calcined at 760 degree Celsius (1400° F.) in air for 2 hours. The resulting phosphorus-doped, rehydrated flash calcined gibbsite had a surface area about 120-170 m²/g.

### EXAMPLE 6

Comparison of Rehydrated Flash Calcined Gibbsite with Unhydrated Flash Calcined Gibbsite.

Tests were conducted on rehydrated flash calcined gibbsite and unhydrated flash calcined gibbsite to compare the sodium content, the surface area and the pore volume. The rehydration of the flash calcined gibbsite was accomplished using formic acid solution as cited above.

TABLE 1
N₂ Porosity and sodium content of fresh flash-calcined gibbsite and
rehydrated flash-calcined gibbsite

| | | BET Surface Area | Pore Volume |
|---|---|---|---|
| Samples | Na₂O, ppm | (m²/g) | (cc/g) |
| Unhydrated | 2900 | 296 | 0.22 |
| flash | | | |
| calcined | | | |
| gibbsite | | | |
| Rehydrated | 150 | 408 | 0.43 |
| flash | | | |
| calcined | | | |
| gibbsite | | | |

The rehydrated flash calcined gibbsite had a drastically lower Na₂O content than the unhydrated sample. The BET surface area increased about 40% from 296 to 408 m²/g and the pore volume almost doubled from 0.22 to 0.43 cc/g.

### EXAMPLE 7

Comparison of Alumina Samples.

Samples were produced of: flash calcined gibbsite, rehydrated flash calcined gibbsite, gamma alumina, lanthanum doped flash calcined gibbsite, lanthanum doped rehydrated flash calcined gibbsite, and lanthanum doped gamma alumina. Each of the doped aluminas was loaded with 3% of lanthanum. Data was taken for each of the six samples after being calcined at 815 degree Celsius (1500° F.)) in air for two hours (Fresh) and 1093 degree Celsius (2000° F.) in air for 4 hours (Aged). Table 2 below shows the data.

TABLE 2

| | | BET | | | | | |
|---|---|---|---|---|---|---|---|
| | | Surface Area | | Pore Volume | | Pore Diameter | |
| | | (m²/g) | | (cc/g) | | (nm) | |
| No. | Samples | 815° C. | 1093° C. | 815° C. | 1093° C. | 815° C. | 1093° C. |
| 1 | Flash-calcined | 100 | 9 | 0.24 | 0.06 | 10 | 27 |
| | gibbsite | | | | | | |
| 2 | Rehydrated | 133 | 8 | 0.49 | 0.06 | 15 | 45 |
| | flash-calcined | | | | | | |
| | gibbsite | | | | | | |
| 3 | Gamma | 125 | 16 | 0.45 | 0.09 | 15 | 23 |
| | alumina | | | | | | |
| 4 | La-doped, | 88 | 8 | 0.22 | 0.08 | 10 | 25 |
| | flash-calcined | | | | | | |
| | gibbsite | | | | | | |
| 5 | La-doped, | 151 | 44 | 0.45 | 0.34 | 15 | 43 |
| | rehydrated | | | | | | |
| | flash-calcined | | | | | | |
| | gibbsite | | | | | | |
| 6 | La-doped, | 132 | 41 | 0.44 | 0.34 | 14 | 33 |
| | gamma | | | | | | |
| | alumina | | | | | | |

The six fresh samples listed above only show a small variation in porosity (BET and pore volume) at the moderate calcination temperature of 815 degree Celsius. On the other hand, a dramatic difference in porosity is noticed among the six samples after being aged at 1093 degree Celsius. Only in the La-stabilized gamma-alumina (Sample No. 6) and the La-stabilized rehydrated flash-calcined gibbsite (Sample No. 5) has enough porosity survived for the alumina to be used in catalyst applications. As matter of fact, the La-stabilized rehydrated flash-calcined gibbsite (sample No. 5) outperformed gamma-alumina (sample No. 3) significantly at 1093 degree C.

The data shows that the doping of rehydrated flash-calcined gibbsite with 3% lanthanum leads to high pore volume and high surface area. The high porosity (high surface area) after 1093 degree Celsius makes the lanthana doped rehydrated flash calcined gibbsite a good support capable of holding a high amount of dispersed metal due to the high surface area. The data also indicates that by using a proper stabilization strategy, such as La-incorporation, a low grade of alumina precursor results in having more desired properties than a high grade γ-alumina.

### EXAMPLE 8

TWC catalyst conversion data: Comparison of lanthana doped rehydratred flash calcined gibbsite supported TWC catalysts and commercial un-doped gamma alumina supported TWC catalysts as automotive catalyst supports. All catalysts were aged and evaluated on vehicle using FTP method.

TABLE 3

| | | | | Precious metal content | | | |
|---|---|---|---|---|---|---|---|
| | | | | | | | Total |
| | | | | | | | Precious |
| Alumina | Conversion % | | | Plat- | Palla- | Rho- | metals |
| Support | HC | CO | NOx | inum | dium | dium | used |
| un-doped, | 58.2 | 56.8 | 57.9 | 4 gms | 0 gms | 2 gms | 6 gcf |
| gamma | | | | | | | |
| alumina | | | | | | | |
| lanthana | 61.6 | 63.6 | 67.9 | 0 gms | 2 gms | 2 gms | 4 gcf |
| doped, | | | | | | | |
| rehy- | | | | | | | |
| dratred | | | | | | | |
| flash | | | | | | | |
| calcined | | | | | | | |
| gibbsite | | | | | | | |

As shown in Table 3, the conversion rates of hydrocarbons, carbon monoxide and nitrogen oxides by the lanthana doped rehydratred flash calcined gibbsite supported TWC catalysts were better than the rates of the gamma alumina supported TWC catalysts. Also, the lanthana doped rehydratred flash calcined gibbsite support used both less precious metals and less platinum than gamma alumina. The use of precious metals, especially the use of platinum by the alumina is known to inflate the cost of the support and thereby the overall cost of the TWC catalysts.

Here the un-doped, gamma alumina used a total of 6 gcf, while the lanthana doped rehydratred flash calcined gibbsite used a total of 4 gcf. In particular, the lanthana doped rehydratred rho-alumina did not use any of the expensive platinum, but the gamma alumina used four grams of platinum. Thus, the lanthana doped rehydratred flash calcined gibbsite support costs less than the gamma alumina support. Example 6 thereby exhibits that the lanthanum-doped rehydrated flash calcined gibbsite supported TWC catalysts gives a higher conversion of HC, CO and NOx at a lower precious metal loading than when the gamma alumina supported TWC catalyst.

What is claimed is:

1. An alumina based catalyst support comprising
a flash-calcined gibbsite rehydrated with an aqueous acidic solution.

2. The support of claim 1, wherein the rehydrated flash-calcined gibbsite has a sodium impurity level of <400 ppm.

3. The support of claim 1, wherein the rehydrated flash-calcined gibbsite is doped with about 0-24 wt. % of a stabilizing metal.

4. The support of claim 3, wherein the rehydrated flash-calcined gibbsite is doped with about 0.1-12 wt. % a stabilizing metal.

5. The support of claim 3, wherein the rehydrated flash-calcined gibbsite is doped with about 1-12 wt. % of a stabilizing metal.

6. The support of claim 3, wherein the stabilizing metal includes alkaline earth metals, boron, silicon, phosphorus, rare-earth metals and combinations thereof with lanthanum.

7. The support of claim 3, wherein the doped rehydrated flash-calcined gibbsite is calcined and the stabilizing metal is in the form of the oxide thereof.

8. The support of claim 1, wherein the surface area of the support is over 80 m²/g.

9. The support of claim 1, wherein the pore volume of the support is at least 0.20 cc/g.

10. The support of claim 1, further comprising at least one precious metal or base metal catalyst supported thereon.

11. A method of catalytically converting a gaseous stream from an internal combustion engine by contacting the stream with a catalyst support comprising flash-calcined gibbsite rehydrated with an aqueous acidic solution and at least one precious metal or base metal catalyst supported thereon.

12. The method of claim 11, wherein the rehydrated flash-calcined gibbsite is doped with about 0-24 wt. % of a stabilizing metal.

13. The support of claim 12, wherein the stabilizing metal includes alkaline earth metals, boron, silicon, phosphorus, rare-earth metals and combinations thereof with lanthanum.

14. The support of claim 12, wherein the doped rehydrated flash-calcined gibbsite is calcined and the stabilizing metal is in the form of the oxide thereof.

15. The method of claim 12, wherein the precious metals provide three way conversion of said gaseous stream.

16. A method of making catalyst support comprising the step of:
rehydrating a flash-calcined gibbsite with an aqueous acidic solution.

17. The method of claim 16, wherein the rehydrated flash-calcined gibbsite is rehydrated with an acidic aqueous solution having a pH of about 2-5.

18. The method of claim 16, wherein the rehydrated flash-calcined gibbsite is doped with about 0-24 wt. % of a stabilizing metal.

19. The method of claim 18, wherein the stabilizing metal includes alkaline earth metals, boron, silicon, phosphorus, rare-earth metals and combinations thereof with lanthanum.

20. The method of claim 19, wherein the doped rehydrated flash-calcined gibbsite is calcined from 550-1100 degree Celsius and the stabilizing metal is in the form of the oxide thereof.
